(19) United States
(12) Patent Application Publication
(10) Pub. No.: US 2009/0259405 A1
(43) Pub. Date: Oct. 15, 2009

(54) METHODS, SYSTEMS, AND COMPUTER-READABLE MEDIA FOR GENERATING SEISMIC EVENT TIME HISTORIES

(75) Inventor: Robert E. Spears, Idaho Falls, ID (US)

Correspondence Address: TraskBritt / Battelle Energy Alliance, LLC, PO Box 2550, Salt Lake City, UT, 84110, US

(73) Assignee: BATTELLE ENERGY ALLIANCE, LLC, IDAHO FALLS, ID (US)

(21) Appl. No.: 12/103,295

(22) Filed: Apr. 15, 2008

(51) Int. Cl. G01V 1/28

(52) U.S. Cl. 702/14

(57) ABSTRACT

Methods, systems, and computer-readable media generate acceleration time histories. An initial acceleration history is applied to a response model with natural frequencies across a spectrum of interest to develop a displacement response. Low-frequency enhancement signals are determined by comparing the displacement response to a standard displacement response. The enhancement signals are combined with the initial acceleration history to develop a second acceleration history, which is applied to the response model to develop an acceleration response. High-frequency enhancement signals are determined by comparing the acceleration response to a standard acceleration response. The enhancement signals are combined with the second acceleration history to develop a desired acceleration history. Acceleration histories also may be created by adding random phase angles at various frequencies to an initial acceleration history in the frequency domain, which is then converted to the time domain and scaled to generate a low-correlation history.

### GOVERNMENT RIGHTS

The United States Government has certain rights in this invention pursuant to Contract No. DE-AC07-05-ID14517, between the United States Department of Energy and Battelle Energy Alliance, LLC.

### TECHNICAL FIELD

Embodiments of the present invention relate generally to methods for analyzing and modifying time histories of acceleration data. More specifically, embodiments of the present invention relate to analyzing, modifying, and generating time histories that cover desired spectra useful in earthquake modeling and analysis.

### BACKGROUND

In the design of man-made structures that are attached to the earth, it is often necessary to estimate how those man-made structures respond to earthquakes or other seismic events. Generally, in these estimates, linear and non-linear computer models may be defined to model the man-made structure. The computer model may then be stimulated with acceleration time histories that represent, or approximate, the seismic event in question.

In an effort to cover a large variety of possible earthquakes, standards organizations, such as the American Society of Civil Engineers (ASCE), have defined desired characteristics for these stimulation histories in standards such as ASCE 43-05. These standards are typically defined as response spectra over a frequency range of interest. A response spectra is defined as how a damped oscillator model will respond to stimulation from the acceleration time history over a frequency of interest. Thus, to develop a response spectra, a damped oscillator model with a specific natural frequency is stimulated by the acceleration time history to determine how it responds. Then another damped oscillator model with another specific natural frequency is stimulated by the same acceleration time history to determine how the model at this frequency responds. This simulation is repeated for a number of frequencies, often over multiple decades of frequency, to develop the response spectra.

To ensure that the acceleration time histories are not completely synthetic and don't represent real-life possibilities, it is often desirable to use time histories that are empirically collected from real-life seismic events. Thus, it may be desirable to use a stimulation history that is collected from an actual earthquake that occurred near where the man-made structure is to be placed. However, often these actual stimulation histories do not conform to the broad response spectrum defined by the standards organizations.

As a result, spectrum matching procedures have been proposed to adjust an initial acceleration time history such that it maintains many of its acceleration, velocity, displacement, and cumulative energy characteristics, but also more closely matches a desired response spectrum, such as those proposed in ASCE 43-05.

However, these proposed spectrum matching procedures use matrix inversion techniques that can be extremely compute intensive. In addition, these proposed spectrum matching procedures match acceleration response spectra, but may not provide good matching for displacement response spectra.

There remains a desire in the art to improve upon existing technologies and to provide methods, systems, and computer-readable media for creating acceleration time histories of seismic events that efficiently use computational power to match desired acceleration and displacement response spectra.

### BRIEF SUMMARY OF THE INVENTION

Embodiments of the present invention provide methods, systems, and computer-readable media for creating acceleration time histories of seismic events that efficiently use computational power to match desired acceleration and displacement response spectra.

In one embodiment of the present invention a method of generating a desired acceleration time history includes supplying a response model comprising a plurality of natural frequencies across a spectrum of interest, generating a second acceleration time history, generating a third acceleration time history, and outputting the third acceleration time history as the desired acceleration time history. Generating the second acceleration time history includes determining a displacement response by applying a first acceleration time history to the response model. The displacement response is compared to a standard displacement response over at least a low frequency band of the spectrum of interest to determine a first set of low-frequency enhancement signals across the low frequency band. The second acceleration time history is produced by combining the first set of low-frequency enhancement signals with the first acceleration time history. Generating the third acceleration time history includes determining an acceleration response by applying the second acceleration time history to the response model. The acceleration response is compared to a standard acceleration response across at least a high frequency band of the spectrum of interest to determine a first set of high-frequency enhancement signals across the high frequency band. The third acceleration time history is produced by combining the first set of high-frequency enhancement signals with the second acceleration time history.

In accordance with another embodiment of the present invention, another method of generating a desired acceleration time history includes supplying a response model comprising a plurality of natural frequencies across a spectrum of interest. An initial acceleration time history is applied to the response model to develop a displacement response. The method also includes determining a set of low-frequency enhancement signals across a lower band of the spectrum of interest by comparing the displacement response to a standard displacement response. The set of low-frequency enhancement signals is combined with the initial acceleration time history to develop a second acceleration time history. The second acceleration time history is applied to the response model to develop an acceleration response. The method also includes determining a set of high-frequency enhancement signals across an upper band of the spectrum of interest by comparing the acceleration response to a standard acceleration response. The set of high-frequency enhancement signals is combined with the second acceleration time history to develop the desired acceleration time history.

In accordance with yet another embodiment of the present invention a method of generating a desired acceleration time history includes converting an initial acceleration time history to a frequency domain to create an initial acceleration frequency record. A running time average is determined by averaging a plurality of contiguous points across the initial acceleration time history and a running frequency average is determined by averaging a plurality of contiguous points across the initial acceleration frequency record. The method includes interpolating between the initial acceleration frequency record and the running frequency average to generate an intermediate frequency record. Substantially random phase angles are inserted at a plurality of frequency points in the intermediate frequency record and the intermediate frequency record is converted to a time domain to a create an intermediate time history. A low-correlation acceleration time history is generated by interpolating between the intermediate time history and the running time average.

In accordance with another embodiment of the present invention, a computing system includes a memory configured for storing computing instructions and a processor operably coupled to the computing system and configured for executing the computing instructions. When executed by the processor, the computing instructions generate a second acceleration time history, generate a third acceleration time history, and output the third acceleration time history as a desired acceleration time history. Generating the second acceleration time history includes determining a displacement response by applying a first acceleration time history to a response model configured with a plurality of natural frequencies across a spectrum of interest. The displacement response is compared to a standard displacement response over at least a low frequency band of the spectrum of interest to determine a first set of low-frequency enhancement signals across the low frequency band. The second acceleration time history is produced by combining the first set of low-frequency enhancement signals with the first acceleration time history. Generating the third acceleration time history includes determining an acceleration response by applying the second acceleration time history to the response model. The acceleration response is compared to a standard acceleration response across at least a high frequency band of the spectrum of interest to determine a first set of high-frequency enhancement signals across the high frequency band. The third acceleration time history is produced by combining the first set of high-frequency enhancement signals with the second acceleration time history.

In accordance with still another embodiment of the present invention, a computer-readable media includes computer executable instructions, which when executed on a processor develop a displacement response by applying an initial acceleration time history to a response model configured with a plurality of natural frequencies across a spectrum of interest. A first set of low-frequency enhancement signals across a lower band of the spectrum of interest is determined by comparing the displacement response to a standard displacement response. The first set of low-frequency enhancement signals is combined with the initial acceleration time history to develop a second acceleration time history. The second acceleration time history is applied to the response model to develop an acceleration response. A first set of high-frequency enhancement signals across an upper band of the spectrum of interest is determined by comparing the acceleration response to a standard acceleration response. The first set of high-frequency enhancement signals are combined with the second acceleration time history to develop a desired acceleration time history, which is output by the processor executing computing instructions.

### BRIEF DESCRIPTION OF THE SEVERAL VIEWS OF THE DRAWINGS

FIG. 1 is a simplified block diagram of a computing system 100 configured for carrying out one or more embodiments of the present invention;

FIG. 2 illustrates acceleration, velocity, and displacement time histories that may be used as a starting point for carrying out embodiment of the present invention;

FIG. 3 illustrates a frequency domain representation of the acceleration time history of FIG. 2;

FIG. 4 illustrates a cumulative energy ratio over time for the acceleration time history of FIG. 2;

FIG. 5 illustrates response spectra for acceleration, velocity, and displacement relative to desired response spectra for the starting point time histories of FIG. 2;

FIGS. 6A-6C are simplified flow diagrams illustrating a process for generating new acceleration time histories according to one or more embodiments of the present invention;

FIG. 7 illustrates response spectra for acceleration, velocity, and displacement relative to the desired response spectra after a first spectral matching process;

FIG. 8 illustrates response spectra for acceleration, velocity, and displacement relative to the desired response spectra after a second spectral matching process;

FIG. 9 illustrates response spectra for acceleration, velocity, and displacement relative to the desired response spectra after a third spectral matching process;

FIG. 10 illustrates response spectra for acceleration, velocity, and displacement relative to the desired response spectra after a fourth spectral matching process;

FIG. 11 illustrates response spectra for acceleration, velocity, and displacement relative to the desired response spectra after a fifth spectral matching process;

FIG. 12 illustrates response spectra for acceleration, velocity, and displacement relative to the desired response spectra after a sixth spectral matching process;

FIG. 13 illustrates final acceleration, velocity, and displacement time histories after the sixth spectral matching process;

FIG. 14 illustrates a cumulative energy ratio over time for the acceleration time history of FIG. 2 and the acceleration time history after the sixth spectral matching process;

FIG. 15 is a simplified flow diagrams illustrating a spectral modification process to generate an acceleration time history with low correlation to an initial acceleration time history;

FIG. 16 illustrates an acceleration time histories and a running time average according to one or more embodiments of the present invention;

FIG. 17 illustrates a frequency domain representation of the acceleration time history of FIG. 16 and a running frequency average according to one or more embodiments of the present invention;

FIG. 18 illustrates an initial displacement time history and a new displacement time history after a portion of the spectral modification process; and

FIG. 19 illustrates a final displacement time history after the spectral modification process relative to the initial displacement time history.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those of ordinary skill in the art to practice the invention. It should be understood, however, that the detailed description and the specific examples, while indicating examples of embodiments of the invention, are given by way of illustration only and not by way of limitation. From this disclosure, various substitutions, modifications, additions rearrangements, or combinations thereof within the scope of the present invention may be made and will become apparent to those skilled in the art.

Embodiments of the present invention provide methods, systems, and computer-readable media for creating acceleration time histories of seismic events that efficiently use computational power to match desired acceleration and displacement response spectra.

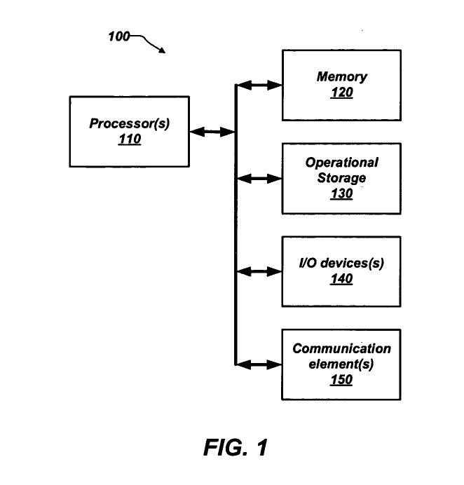

FIG. 1 is a simplified block diagram of a computing system 100 configured for carrying out one or more embodiments of the present invention. The computing system 100 is configured for executing software programs containing computing instructions and may include one or more processors 110, memory 120, operational storage 130, one or more communication elements 150, and one or more Input/Output (I/O) devices 140.

The one or more processors 210 may be configured for executing a wide variety of operating systems and applications including the computing instructions for carrying out embodiments of the present invention.

The memory 120 may be used to hold computing instructions, data, and other information for performing a wide variety of tasks including performing embodiments of the present invention. By way of example, and not limitation, the memory 120 may include Synchronous Random Access Memory (SRAM), Dynamic RAM (DRAM), Read-Only Memory (ROM), Flash memory, and the like.

The communication elements 150 may be configured for communicating with other devices or communication networks. By way of example, and not limitation, the communication elements 150 may include elements for communicating on wired and wireless communication media, such as for example, serial ports, parallel ports, Ethernet connections, universal serial bus (USB) connections IEEE 1394 (“firewire”) connections, bluetooth wireless connections, 802.1 a/b/g/n type wireless connections, cellular phone wireless connections and other suitable communication interfaces and protocols.

The operational storage 130 may be used for storing large amounts of non-volatile information for use in the computing system 100. The operational storage 130 may be configured as one or more storage devices. By way of example, and not limitation, these storage devices may include computer-readable media (CRM). This CRM may include, but is not limited to, magnetic, optical, and solid state storage devices such as disk drives, magnetic tapes, CDs (compact disks), DVDs (digital versatile discs or digital video discs), FLASH memory, and other equivalent storage devices.

Software processes illustrated herein are intended to illustrate representative processes that may be performed by one or more computing system in carrying out embodiments of the present invention. Unless specified otherwise, the order in which the processes are described is not to be construed as a limitation. Furthermore, the processes may be implemented in any suitable hardware, software, firmware, or combinations thereof. By way of example, software processes may be stored on one or more storage devices 130, transferred to a memory 120 for execution, and executed by one or more processors 110.

When executed as firmware or software, the instructions for performing the processes may be stored or transferred on a computer-readable medium. A computer-readable medium includes, but is not limited to, magnetic and optical storage devices such as disk drives, magnetic tape, CDs (compact disks), DVDs (digital versatile discs or digital video discs), and semiconductor devices such as RAM, DRAM, ROM, EPROM, and Flash memory.

Also, it is noted that the examples may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

A number of different waveforms are discussed herein. As used herein, a “time history” is a waveform depicting acceleration, velocity, or displacement in a “time domain” over a time period of interest. As illustrated herein, the time history waveforms include sample points at 0.005 second intervals over about 40 seconds. Of course, embodiments of the present invention may use time histories of a different length of time and with a different sampling interval.

A “frequency record” is a waveform depicting acceleration, velocity, or displacement in the “frequency domain.” The frequency records may be derived from time histories using methods known in the art, such as, for example, Fourier transforms. Conversely, time histories may be derived from frequency records using methods known in the art, such as, for example, inverse Fourier transforms.

A “response spectrum” is a waveform depicting how a response model responds to stimulus from an acceleration time history. Response spectra may be determined for acceleration, velocity, displacement, or combinations thereof. The response model may be considered as a damped oscillator model with a natural frequency. To generate a response spectra, the natural frequency is set to a specific frequency, for example one Hz, then stimulated by the acceleration time history to generate an acceleration response, a velocity response, and a displacement response in the time domain. The largest peak for each of acceleration, velocity and displacement in the time domain is selected as the response at that natural frequency. The response model is then set to a new natural frequency, for example two Hz, and stimulated again with the same acceleration time history. The peaks for acceleration, velocity, and displacement for this new simulation are selected as the response for this natural frequency. This process is repeated for many frequencies across a spectrum of interest to generate the response spectra for acceleration, velocity, and displacement.

As illustrated herein, response spectra are shown for a spectrum of interest from 0.1 Hz to 100 Hz spanning three decades. 100 sample points (i.e., natural frequencies for the response model) are calculated for each decade to form a response spectrum across the spectrum of interest with a total of 300 sample points. For the discussions herein, these sample points and spectrum of interest were selected to conform to the standards defined in ASCE 43-05. Of course, embodiments of the present invention may use response spectra across a different spectrum of interest and with a different number of sample points.

Embodiments of the present invention begin with an acceleration time history representing a seismic event. For ease of explanation, a seismic event may be referred to herein as an earthquake. However, unless specified otherwise, earthquake should be interpreted to mean any seismic event, such as, for examples, earthquakes, bomb blasts, and other large forces capable of causing displacement in the ground proximate an area of interest.

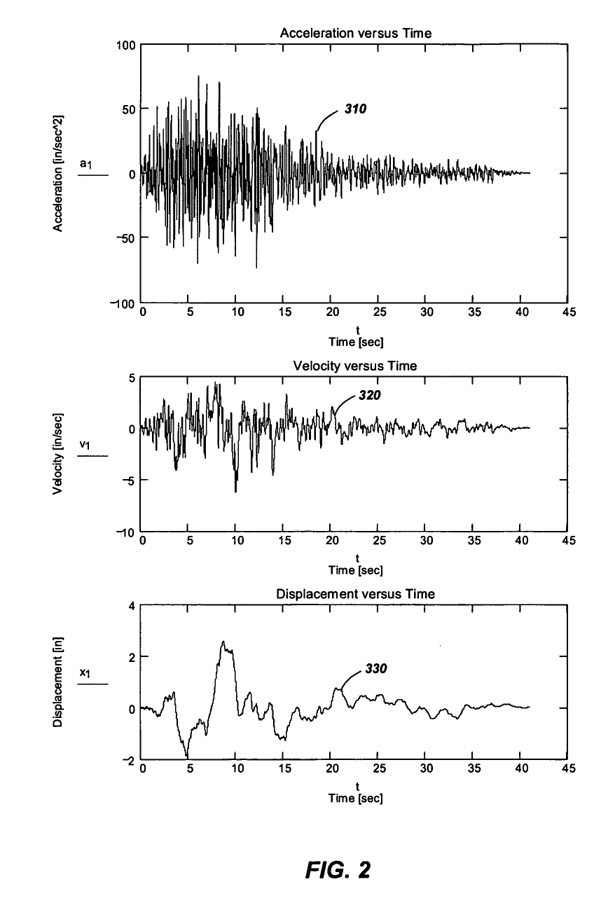

FIG. 2 illustrates acceleration, velocity, and displacement time histories that may be used as a starting point for carrying out embodiment of the present invention. The initial acceleration time history 310 may be synthetically generated or may be empirical data gathered from an actual earthquake near the area of interest. The initial velocity time history 320 may be generated by integrating the initial acceleration time history 310 with numerical analysis methods known in the art. Similarly, the initial displacement time history 330 may be generated by integrating the velocity time history 320 with numerical analysis methods known in the art.

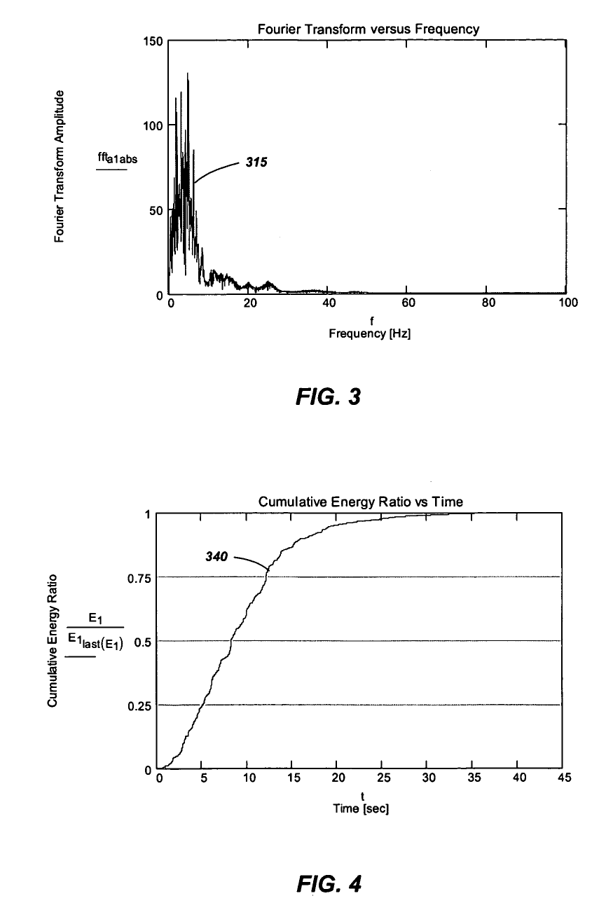

FIG. 3 illustrates an initial acceleration frequency record 315 (i.e., a frequency domain representation of the initial acceleration time history 310 of FIG. 2). For many processes described herein, operations and selections of frequencies based on amplitudes may be more easily determined in the frequency domain. While not illustrated, those of ordinary skill in the art will recognize that a similar frequency domain representation may be generated for a velocity time history and a displacement time history.

FIG. 4 illustrates an initial cumulative energy ratio 340 over time for the initial acceleration time history 310 of FIG. 2. Cumulative energy is a measure over time of how much energy is being imposed on a system. As non-limiting examples, the cumulative energy ratio 340 may be determined using a trapezoidal rule evaluation, sum-of-the-squares analysis of the acceleration, or other suitable means.

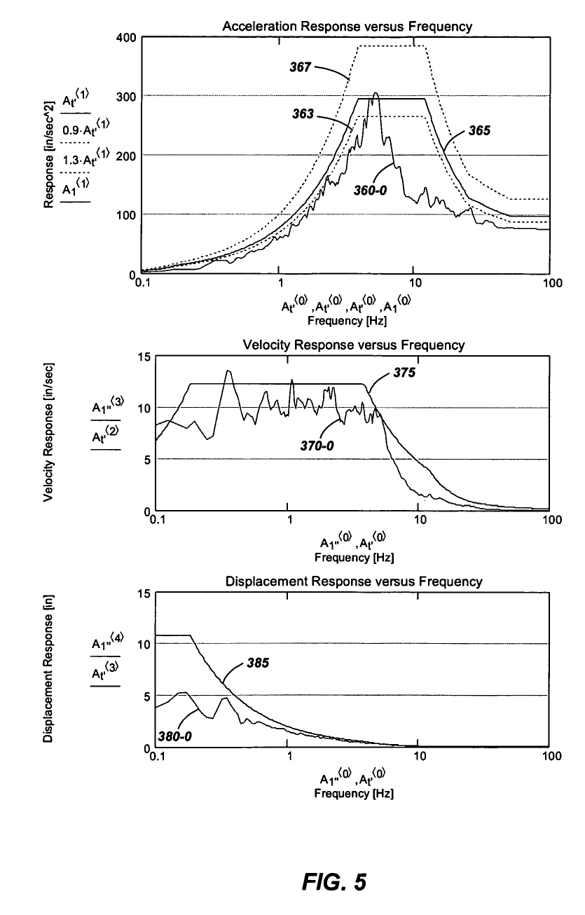

FIG. 5 illustrates response spectra for acceleration, velocity, and displacement relative to desired response spectra for the starting time histories of FIG. 2. Standards for earthquake responses (e.g., ASCE 43-05) define standard response spectra that are desired for acceleration time histories, velocity time histories, and displacement time histories. These standard response spectra generally define a conservative model to cover a broad range of potential seismic events.

In the upper graph of FIG. 5, an initial acceleration response 360-0 is shown relative to a standard acceleration response 365. Also illustrated are an upper limit acceleration response 367 and a lower limit acceleration response 363. In the middle graph of FIG. 5, an initial velocity response 370-0 is shown relative to a standard velocity response 375. In the lower graph of FIG. 5, an initial displacement response 380-0 is shown relative to a standard displacement response 385. As discussed earlier, the initial acceleration response 360-0, initial velocity response 370-0, and initial displacement response 380-0 are derived by stimulating a response model with the initial acceleration time history 310 from FIG. 2.

As can be seen in FIG. 5, the initial acceleration response 360-0, the initial velocity response 370-0, and the initial displacement response 380-0 deviate substantially from the standard acceleration response 365, the standard velocity response 375, and the standard displacement response 385, respectively. Embodiments of the present invention generate a new acceleration time history from the initial acceleration time history 310 such that when the new acceleration time history stimulates the response model, new acceleration, velocity, and displacement response spectra (generically numbered as 360, 370, and 380) more closely match the standard acceleration, velocity and displacement response spectra (365, 375, and 385).

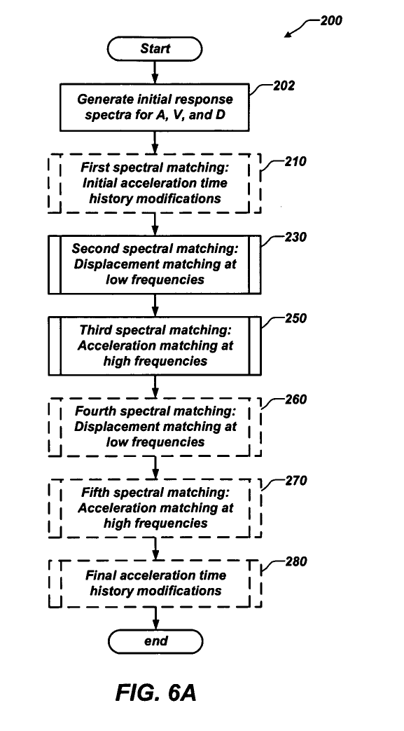

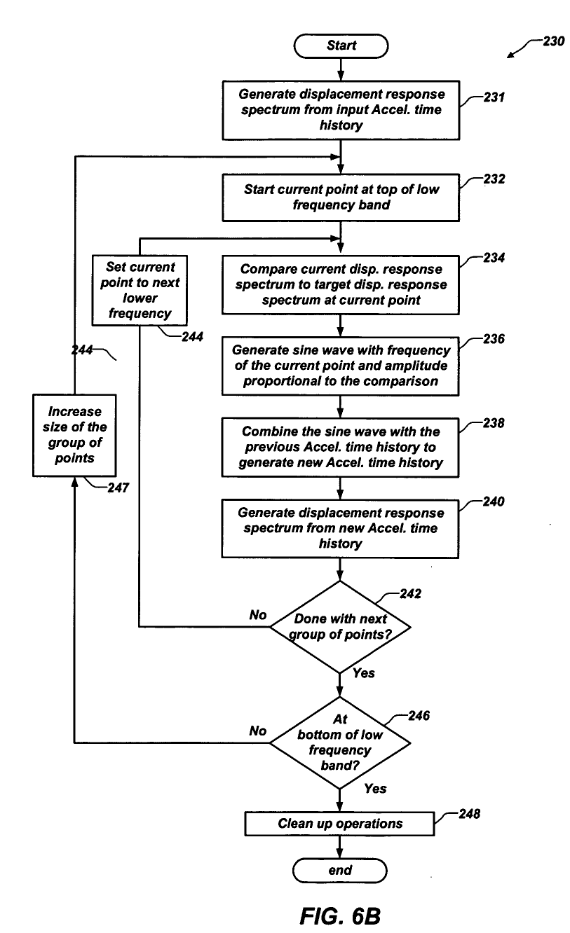

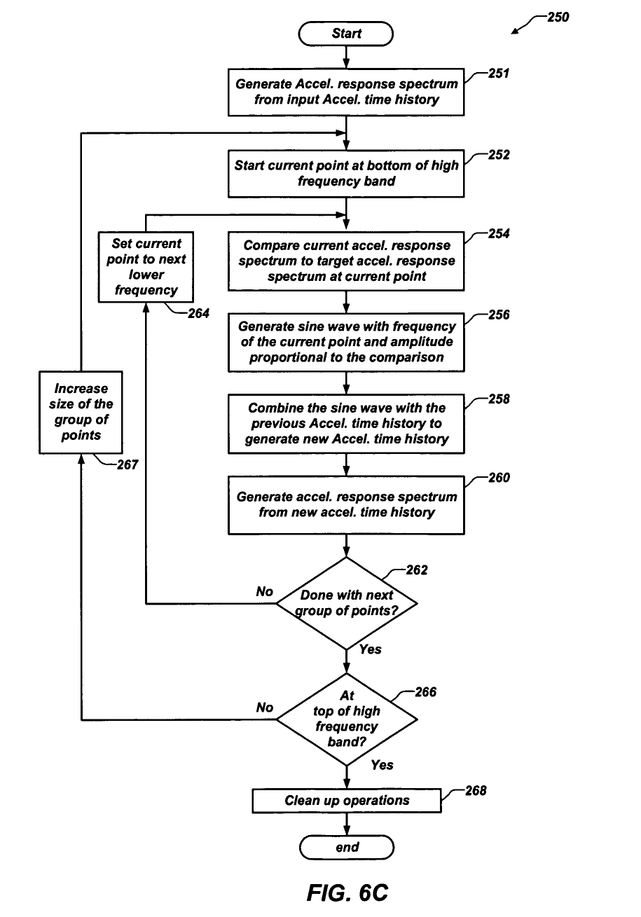

FIGS. 6A-6C are simplified flow diagrams illustrating a time history generation process 200 for generating new acceleration time histories. The new acceleration time histories are modified through a series of spectral matching processes that modify and refine the new acceleration time histories such that acceleration, velocity and displacement response spectra generated from the new acceleration time histories more closely match the standard responses 365, 375, and 385, illustrated in FIG. 5.

Some of these refinement processes are optional and are illustrated with dashed lines. In FIG. 6A, the time history generation process 200 begins with operation block 202 by generating initial acceleration, velocity, and displacement response spectra by applying the initial acceleration time history to the response model. These initial response spectra are shown in FIG. 5 as initial acceleration response 360-0, initial velocity response 370-0, and initial displacement response 380-0.

Operation block 210 shows an optional first spectral matching process 210, which scales amplitudes at various frequencies in the frequency domain for the initial time history. First an acceleration response scaling may be performed. With reference to FIG. 5, the amplitude of the initial acceleration response 360-0 is compared to the amplitude of the standard acceleration response 365 at each of the 300 sample points along the three decades from 0.1 Hz to 100 Hz. A target acceleration response is developed for each sample point, which is a relative weighting of the initial acceleration response 360-0 relative to the standard acceleration response 365 at each sample point. The target acceleration response is converted from the frequency domain to the time domain to create a target acceleration adjustment. The target acceleration adjustment and the initial acceleration time history are combined at each time sample point to create a first acceleration time history.

To adjust for changes in cumulative energy, an average is determined for the initial acceleration time history and the first acceleration time history. A scale factor is determined as a ratio of the two averages and is applied to the first acceleration time history so the cumulative energy of the first acceleration time history more closely matches the cumulative energy of the initial acceleration time history. This cumulative energy adjustment may be performed after many of the adjustment steps described herein.

In addition, when adjustments are made to the acceleration time history, it may cause drift in the velocity and displacement time histories near the start of the time histories and the end of the time histories such that they do not approach zero as they should. Thus, a boundary scaling operation may be performed to correct this drift. In the boundary scaling operation, a beginning portion of the time history and an ending portion of the time history are defined. As a non-limiting example, the beginning portion may be defined as the portion of the time history that is below 5% of the cumulative energy ratio 340 (FIG. 4). Similarly, the ending portion may be defined as the portion of the time history that is above 95% of the cumulative energy ratio 340. To perform the scaling, an input time history (which may be acceleration, velocity, or displacement) and a result time history are used. The input time history is a time history before an adjustment operation is performed and the result time history is a time history after the adjustment operation is performed. At each time history point in the beginning portion and the ending portion, proportional scaling is performed.

Thus, as non-limiting example, for the beginning portion, at time zero only the input time history sample value is used; at a point 25% in from time zero, 25% of the input time history sample value is combined with 75% of the result time history sample value; and at the end of the beginning portion only the result time history sample value is used.

Similarly, for the ending portion, at the end of the ending portion only the input time history sample value is used; at a point 25% lower than the end, 25% of the input time history sample value is combined with 75% of the result time history sample value; and at the start of the ending portion only the result time history sample value is used. This boundary scaling operation may be performed after many of the adjustment steps described herein. This example describes a simple linear scaling, those of ordinary skill in the art will recognize that more complex scaling methods are also contemplated within the scope of the present invention.

A conversion process similar to the acceleration response scaling may be performed for displacement response scaling as part of the first spectral matching process 310. The first acceleration time history generated by the acceleration response scaling is applied to the response model to generate an intermediate displacement response. A target displacement response is developed for each sample point, which is a relative weighting of the intermediate displacement response relative to the standard displacement response 385 at each sample point. Derivatives of the target displacement response are performed to create a target acceleration response, which is then converted to the time domain to create a target acceleration adjustment. The target acceleration adjustment and the first acceleration time history are combined at each time sample point to create a new first acceleration time history. The cumulative energy adjustment and boundary scaling operation described above may be performed on the new first acceleration time history.

A similar conversion process may be performed for velocity response scaling as part of the first spectral matching process 310. The first acceleration time history generated by the displacement response scaling is applied to the response model to generate an intermediate velocity response. A target velocity response is developed for each sample point, which is a relative weighting of the intermediate velocity response relative to the standard displacement response 385 at each sample point. A derivatives of the target velocity response is performed to create a target acceleration response, which is then converted to the time domain to create a target acceleration adjustment. The target acceleration adjustment and the first acceleration time history are combined at each time sample point to create a new first acceleration time history. The cumulative energy adjustment and boundary scaling operation described above may be performed on the new first acceleration time history.

These response scaling operations for acceleration, displacement, and velocity are described as occurring over the entire frequency spectrum of interest. However, they may be applied over a subset of the frequency spectrum. As a non-limiting example, the displacement response scaling may be performed from 0.1 to 0.5 Hz where the standard displacement response is largest.

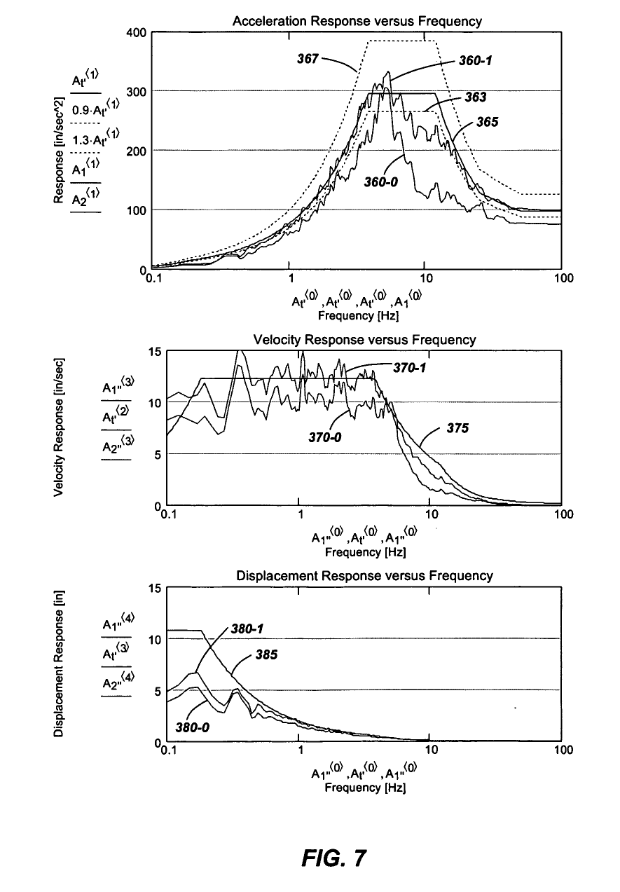

FIG. 7 illustrates response spectra for acceleration, velocity, and displacement relative to the desired response spectra after the first spectral matching process 210 of FIG. 6A. In the upper graph of FIG. 7, the initial acceleration response 360-0 is shown as a reference for where the time history generation process began. Also illustrated for reference are the standard acceleration response 365, the upper limit acceleration response 367 and the lower limit acceleration response 363. A first acceleration response 360-1, resulting from the first spectral matching process 210 of FIG. 6A, more closely matches the standard acceleration response 365. The closer matching is most apparent in a frequency band from about 7 Hz to about 30 Hz where the amplitude of the first acceleration response 360-1 is shown to be significantly higher than the initial acceleration response 360-0 and closer to the standard acceleration response 365. In addition, in a frequency band from about 30 Hz up to the 100 Hz upper limit it can be seen that the first acceleration response 360-1 very closely matches the standard acceleration response 365.

In the middle graph of FIG. 7, the initial velocity response 370-0 and a first velocity response 370-1 are shown relative to the standard velocity response 375. Some attempt is made by embodiments of the present invention to match velocity responses to the standard velocity response 375. However, more effort is taken to match acceleration responses and displacement responses while verifying that velocity responses remain relatively close to the standard velocity response 375.

In the lower graph of FIG. 7, the initial displacement response 380-0 and a first displacement response 380-1 are shown relative to the standard displacement response 385. The first displacement response 380-1, resulting from the first spectral matching process 210 of FIG. 6A, more closely matches the standard displacement response 385. The closer matching is most apparent in a frequency band from about the lower limit of 0.1 Hz to about 0.3 Hz where the amplitude of the first displacement response 380-1 is shown to be somewhat higher than the initial displacement response 380-0 and closer to the standard displacement response 385.

Returning to FIG. 6A, a second spectral matching process 230 compares the first displacement response 380-1 (or initial displacement response 380-0 if operation 210 is not performed) to the standard displacement response 385 across a lower band of frequencies. The second spectral matching process improves the lower frequencies of the response spectra relative to the standard response spectra by analyzing displacement responses at the lower frequencies. The lower band may span the frequencies for 0.1 Hz up to about 3 Hz. As can be seen in FIG. 5, the standard displacement response 385 is quite close to zero at frequencies above 3 Hz. Consequently, the second spectral matching process 230 may have little effect at the higher frequencies. The frequencies used within this lower band are based on the 100 per decade sample points. However, where a sample point in the first displacement response 380-1 does not have a corresponding frequency in the first displacement frequency record (i.e., the frequency domain representation of the first displacement time history) just the available frequencies in the first frequency record are used.

FIG. 6B illustrates details of the second spectral matching process 230. With reference to FIGS. 7 and 6B, in operation block 231, a first displacement response 380-1 is created, if not already created, by stimulating the response model with the first acceleration time history derived from the first spectral matching operation 210. In operation block 232, a current frequency point is defined at the top of the lower band. Operation block 234 compares the first displacement response 380-1 to the standard displacement response 385 at the current frequency point.

Operation block 236 generates an oscillating enhancement signal (e.g., a sine wave or cosine wave) at the current frequency point. In other words, the process starts with a current frequency point at the top of the low frequency band (e.g., 3 Hz) with a 3 Hz sine wave. The oscillating enhancement signal may be a sine wave with an amplitude proportional to a ratio of the first displacement response 380-1 at the current frequency point relative to the standard displacement response 385 at the current frequency point.

Operation block 238 combines this oscillating enhancement signal with the current acceleration time history to generate a new acceleration time history. In operation block 240, a new displacement response is created using the new acceleration time history as a stimulus to the response model. This new displacement response should match a little bit closer to the standard displacement response 385; particularly at the current frequency point. However, even though only a sine wave at a specific frequency has been added to the acceleration time history, the new response spectra may show different displacement responses at a variety of frequencies, not just at the current point.

Decision block 242 checks to see if the process is done with the current group of points. The points may be grouped for repeating the adjustment processes. For example, the first time at decision block 242 the number of points in the group may be a small number, such as, for example three. If the process is not done with the current group of points, operation block 244 sets the current point to the next lower frequency and the inner loop is repeated.

If the process is done with the current group of points, control passes to decision block 246, which checks to see if the process has reached the bottom frequency of the low frequency band. If not, operation block 247 enlarges the group of points to be considered on the next inner loop. As a non-limiting example, the group of points may increase by three. Thus, if the starting group of points was 3, each time through the outer loop the group of points would be enlarged such that 3 points are processed in the inner loop, then 6 points are processed in the inner loop, then 9 points, etc. The process returns to operation block 232 where the current point is reset to the top of the low frequency band and the outer loop is repeated.

If the bottom of the low frequency band has been reached, operation block 248 performs some clean up operations to adjust the cumulative energy ratio and adjust the new acceleration, velocity, and displacement time histories to smoothly transition relative to the previous time histories. These clean up operations may include the cumulative energy adjustment and boundary scaling operation described above. It should be noted that in some embodiments, all or portions of this clean up operation may be performed after every new time history is generated.

The resulting output of the second spectral matching operation 230 is a second acceleration time history (not shown), which may be used to excite the response model to generate second acceleration, velocity, and displacement response spectra.

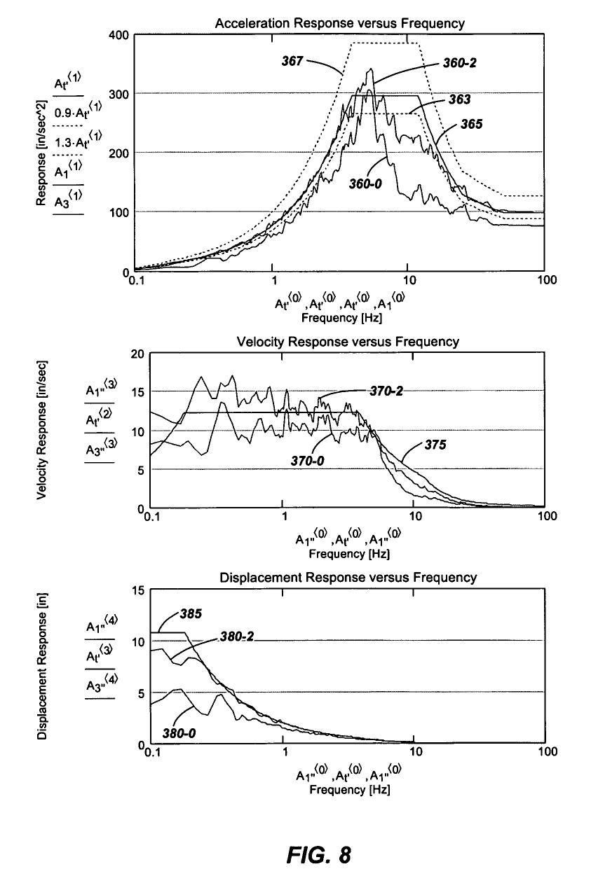

FIG. 8 illustrates response spectra for acceleration, velocity, and displacement relative to the desired response spectra after the second spectral matching process 230 of FIG. 6B. In the upper graph of FIG. 8, the initial acceleration response 360-0, the standard acceleration response 365, the upper limit acceleration response 367 and the lower limit acceleration response 363 are shown for reference. Relative to the initial acceleration response 360-0, a second acceleration response 360-2, resulting from the second spectral matching process 230 of FIG. 6B, more closely matches the standard acceleration response 365. The second spectral matching process 230 uses the displacement response spectra for determining the adjustments to be made to the acceleration time history. However, the adjustments have made significant improvements to the second acceleration response 360-2 relative to the first acceleration response 360-1 in FIG. 7. As can be seen in FIG. 8, the second acceleration response 360-2, more closely matches the standard acceleration response 365. The closer matching is most apparent in a frequency band from about 0.1 Hz to about 10 Hz where the amplitude of the second acceleration response 360-2 very closely matches the standard acceleration response 365. Furthermore, when compared to the first acceleration response 360-1 in FIG. 7, the second acceleration response 360-2 in this lower frequency region is very close to within the upper limit acceleration response 367 and the lower limit acceleration response 363.

In the middle graph of FIG. 8, the initial velocity response 370-0 and a second velocity response 370-2 are shown relative to the standard velocity response 375. As can be seen, the second velocity response 370-2 remains acceptably close to the standard velocity response 375.

In the lower graph of FIG. 8, the initial displacement response 380-0 and a second displacement response 380-2 are shown relative to the standard displacement response 385. The second displacement response 380-2, resulting from the second spectral matching process 230 of FIG. 6B, more closely matches the standard displacement response 385. The closer matching is most apparent in a frequency band from about 0.2 Hz to about 10 Hz where the amplitude of the second displacement response 380-2 very closely matches the standard displacement response 385.

Returning to FIG. 6A, a third spectral matching process 250 compares the second acceleration response 360-2 to the standard acceleration response 365 across an upper band of frequencies. This spectral matching process improves the high frequencies of the response spectra relative to the standard response spectra by analyzing acceleration responses at the high frequencies. The upper band may span the frequencies for 3 Hz up to about 50 Hz. As can be seen in FIG. 8, the standard acceleration response 365 has its highest amplitudes in this range. Consequently, the third spectral matching process 250 may be most effective in this range and this range may be where more adjustments are needed. As with the lower frequency band, the frequencies used within the upper band are based on the 100 per decade sample points.

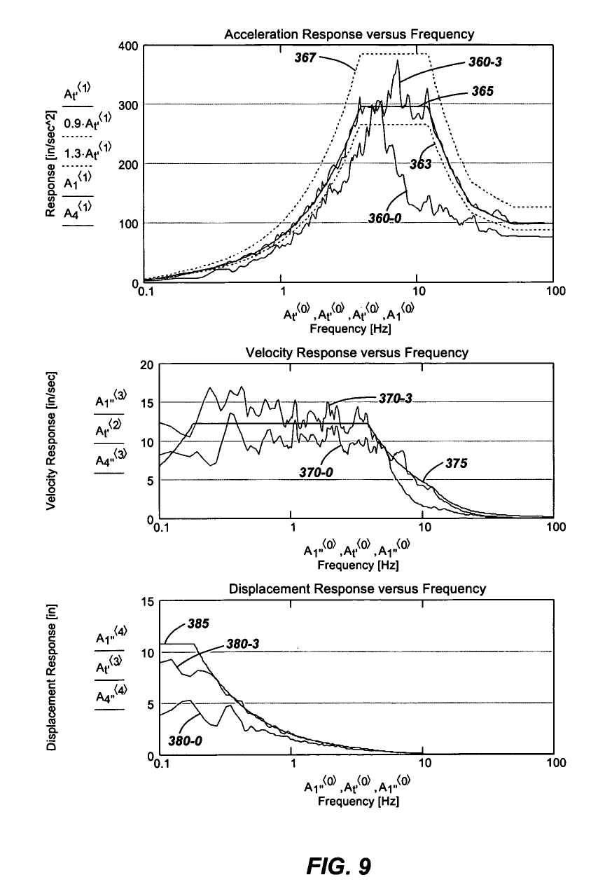

FIG. 6C illustrates details of the third spectral matching process 250. With reference to FIGS. 6C and 9, in operation block 251, a third acceleration response 360-3 is created, if not already created, by stimulating the response model with the second acceleration time history derived from the second spectral matching operation 230. In operation block 252, a current frequency point is defined at the bottom of the upper band (e.g., 3 Hz). Operation block 254 compares the third acceleration response 360-3 to the standard acceleration response 365 at the current frequency point.

Operation block 256 generates an oscillating enhancement signal (e.g., a sine wave or cosine wave) at the current frequency point. In other words, the process starts with a current frequency point at the bottom of the upper frequency band (e.g., 3 Hz) with a 3 Hz sine wave. The oscillating enhancement signal may be a sine wave with an amplitude proportional to a ratio of the third acceleration response 360-3 at the current frequency point relative to the standard acceleration response 365 at the current frequency point.

Operation block 258 combines this oscillating enhancement signal with the current acceleration time history to generate a new acceleration time history. In operation block 260, a new acceleration response is created using the new acceleration time history as a stimulus to the response model. This new acceleration response should match a little bit closer to the standard acceleration response 365; particularly at the current frequency point. However, even though only a sine wave at a specific frequency has been added to the acceleration time history, the new acceleration response may show different acceleration responses at a variety of frequencies, not just at the current point.

Decision block 262 checks to see if the process is done with the current group of points. The points may be grouped for repeating the adjustment processes. For example, the first time to decision block 262 the number of points in the group may be a small number, such as, for example 10. If the process is not done with the current group of points, operation block 264 sets the current point to the next higher frequency and the inner loop is repeated.

If the process is done with the current group of points, control passes to decision block 266, which checks to see if the process has reached the top frequency of the upper frequency band. If not, operation block 267 enlarges the group of points to be considered on the next inner loop. As a non-limiting example, the group of points may increase by 10. Thus, if the starting group of points was 10, each time through the outer loop the group of points would be enlarged such that 10 points are processed in the inner loop, then 20 points are processed in the inner loop, then 30 points, etc. The process returns to operation block 252 where the current point is reset to the bottom of the upper band and the outer loop is repeated.

If the top of the upper frequency band has been reached, operation block 268 performs some clean up operations to adjust the cumulative energy ratio and adjust the new acceleration, velocity, and displacement time histories to smoothly transition relative to the previous time histories. These clean up operations may include the cumulative energy adjustment and boundary scaling operation described above. It should be noted that in some embodiments, all or portions of this clean up operation may be performed after every new time history is generated.

The resulting output of the third spectral matching operation 250 is a third acceleration time history (not shown), which may be used to excite the response model to generate third acceleration, velocity, and displacement responses.

FIG. 9 illustrates response spectra for acceleration, velocity, and displacement relative to the desired response spectra after a third spectral matching process 250 of FIG. 6C. In the upper graph of FIG. 9, the initial acceleration response 360-0, the standard acceleration response 365, the upper limit acceleration response 367 and the lower limit acceleration response 363 are shown for reference. Relative to the initial acceleration response 360-0, a third acceleration response 360-3, resulting from the third spectral matching process 250 of FIG. 6C, more closely matches the standard acceleration response 365. When compared to the second acceleration response 360-2 in FIG. 8, it can be seen that the amplitudes in the frequency band from about 0.8 Hz to about 10.5 Hz have been raised to very closely match the standard acceleration response 365.

In the middle graph of FIG. 9, the initial velocity response 370-0 and a third velocity response 370-3 are shown relative to the standard velocity response 375. As can be seen, the third velocity response 370-3 remains acceptably close to the standard velocity response 375.

In the lower graph of FIG. 9, the initial displacement response 380-0 and a third displacement response 380-3 are shown relative to the standard displacement response 385. The third displacement response 380-3, resulting from the third spectral matching process 250 of FIG. 6C, more closely matches the standard displacement response 385. However, when compared to the second displacement response 380-2 in FIG. 8, there is not a significant difference. This is because the third spectral matching process 250 is targeted to adjusting the acceleration response.

Returning to FIG. 6A, a fourth spectral matching process 260 may be used to compare the fourth displacement response 380-4 to the standard displacement response 385 across a lower band of frequencies. The fourth spectral matching process improves the lower frequencies of the response spectra relative to the standard response spectra by analyzing displacement responses at the lower frequencies. This fourth spectral matching process is similar to the second spectral matching process 230 with a few minor changes. In the fourth spectral matching process 260, the lower band may span a smaller or larger set of frequencies, such as, for example from about 0.1 Hz to about 1 Hz. In addition, the groupings may be smaller or larger. Thus, in the fourth spectral matching process a grouping of one may be used rather than a grouping of three. As a result, the first time processing the inner loop one frequency is processed, the second time processing the inner loop two frequencies are processed, the third time processing the inner loop three frequencies are processed, etc.

The resulting output of the fourth spectral matching operation 260 is a fourth acceleration time history (not shown), which may be used to excite the response model to generate fourth acceleration, velocity, and displacement responses.

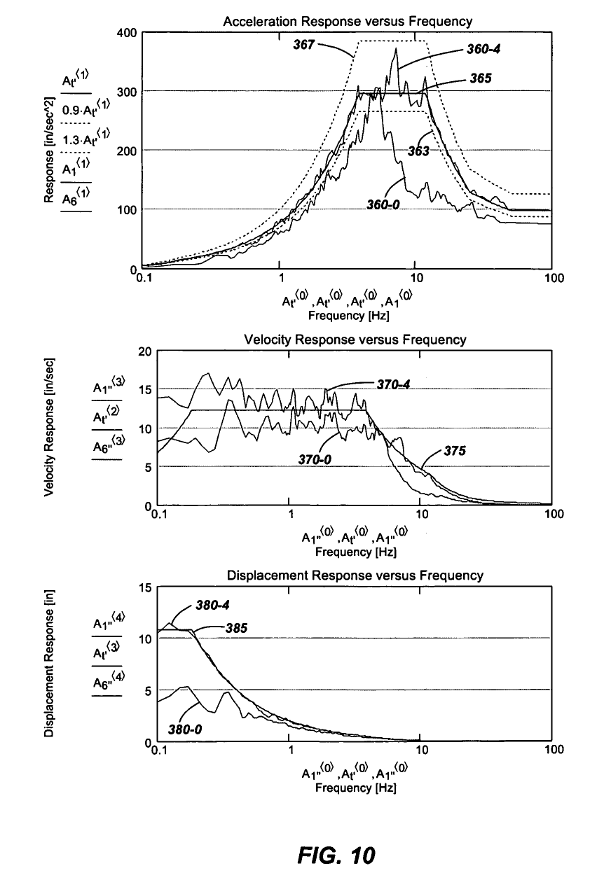

FIG. 10 illustrates response spectra for acceleration, velocity, and displacement relative to the desired response spectra after the fourth spectral matching process 260 of FIG. 6A. In the upper graph of FIG. 10, the initial acceleration response 360-0, the standard acceleration response 365, the upper limit acceleration response 367 and the lower limit acceleration response 363 are shown for reference. Relative to the initial acceleration response 360-0, a fourth acceleration response 360-4, resulting from the fourth spectral matching process 270 of FIG. 6A, more closely matches the standard acceleration response 365. As with the second spectral matching process 230, the fourth spectral matching process 260 uses the displacement response spectra for determining the adjustments to be made to the acceleration time history to also make significant improvements to the fourth acceleration response 360-4 relative to the third acceleration response 360-3 (FIG. 9). These improvements are most apparent in a frequency band from about 0.1 Hz to about 10 Hz. Furthermore, when compared to the first acceleration response 360-1 in FIG. 7, the fourth acceleration response 360-4 in this lower frequency region is now within the upper limit acceleration response 367 and the lower limit acceleration response 363.

In the middle graph of FIG. 10, the initial velocity response 370-0 and a fourth velocity response 370-4 are shown relative to the standard velocity response 375. As can be seen, the fourth velocity response 370-4 remains acceptably close to the standard velocity response 375.

In the lower graph of FIG. 10, the initial displacement response 380-0 and a fourth displacement response 380-4 are shown relative to the standard displacement response 385. The fourth displacement response 380-4, resulting from the fourth spectral matching process 270 of FIG. 6B, more closely matches the standard displacement response 385. The closer matching is most apparent in a frequency band from about 0.1 Hz to about 0.2 Hz where the amplitude of the fourth displacement response 380-4 very closely matches the standard displacement response 385 and is significantly higher than the third displacement response 380-3 in FIG. 9.

Returning to FIG. 6A, a fifth spectral matching process 270 may be used to compare the fourth acceleration response 360-4 to the standard acceleration response 385 across an upper band of frequencies. The fifth spectral matching process 270 improves the higher frequencies of the response spectra relative to the standard response spectra by analyzing acceleration responses at the higher frequencies. This fifth spectral matching 270 process is similar to the third spectral matching process 230 with a few minor changes. In the fifth spectral matching process 270, upper band may span a larger set of frequencies, such as, for example from about 0.5 Hz to about 50 Hz. In addition, the groupings may be set to encompass the entire frequency band such that the entire frequency band is swept in a group. Finally, this sweep through the entire frequency band may be repeated many times, such as, for example, 50 times.

The resulting output of the fifth spectral matching operation 270 is a fifth acceleration time history (not shown), which may be used to excite the response model to generate fifth acceleration, velocity, and displacement responses.

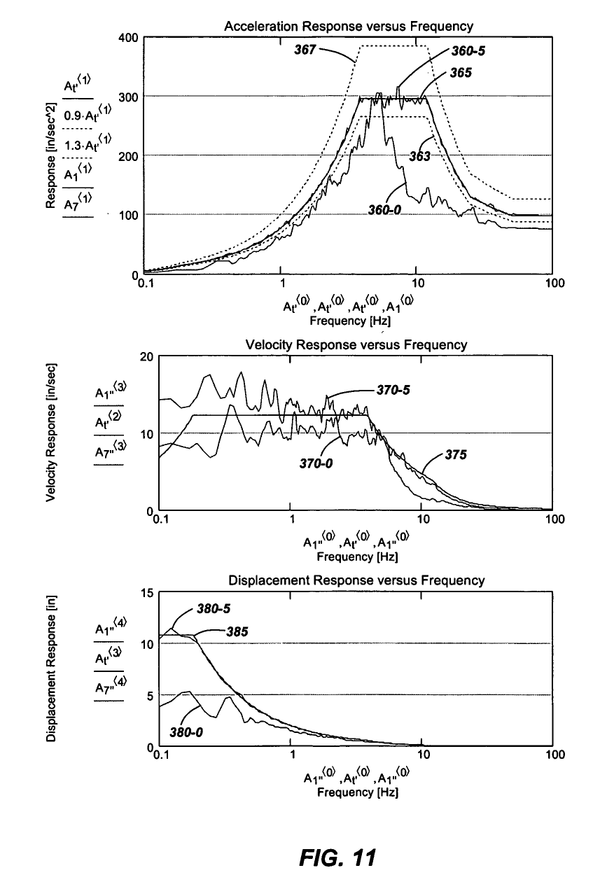

FIG. 11 illustrates response spectra for acceleration, velocity, and displacement relative to the desired response spectra after the fifth spectral matching process 280 of FIG. 6A. In the upper graph of FIG. 11, the initial acceleration response 360-0, the standard acceleration response 365, the upper limit acceleration response 367 and the lower limit acceleration response 363 are shown for reference. Relative to the initial acceleration response 360-0, a fifth acceleration response 360-5, resulting from the fifth spectral matching process 380 of FIG. 6A, more closely matches the standard acceleration response 365. When compared to the fourth acceleration response 360-4 in FIG. 10, it can be seen that the amplitudes for the fifth acceleration response 360-5 in the frequency band from about 3 Hz to about 10.5 Hz have been refined to limit spikes and very closely match the standard acceleration response 365.

In the middle graph of FIG. 11, the initial velocity response 370-0 and a fifth velocity response 370-5 are shown relative to the standard velocity response 375. As can be seen, the fifth velocity response 370-5 remains acceptably close to the standard velocity response 375.

In the lower graph of FIG. 11, the initial displacement response 380-0 and a fifth displacement response 380-5 are shown relative to the standard displacement response 385. The fifth displacement response 380-5, resulting from the fifth spectral matching process 280 of FIG. 6A, more closely matches the standard displacement response 385. However, when compared to the fourth displacement response 380-4 in FIG. 10, there is not a significant difference. This is because the fifth spectral matching process 280 is targeted to adjusting the acceleration response.

Returning to FIG. 6A, a sixth spectral matching process 280 may be used to further refine the fifth acceleration time history 360-5. The sixth spectral matching process 280 improves a large band of the frequencies with the spectrum of interest by analyzing acceleration responses across this large band of frequencies. This sixth spectral matching 280 process is similar to the third spectral matching process 250 with a few minor changes. In the sixth spectral matching process 270, the larger band may span almost all the frequencies, such as, for example from about 0.25 Hz to about 100 Hz. In addition, the groupings may be set to encompass the entire frequency band such that the entire frequency band is swept in a group. Finally, this sweep through the entire frequency band may be repeated many times, such as, for example, 35 times. The resulting output of the sixth spectral matching operation 280 is a sixth acceleration time history (not shown), which is the final desired acceleration time history.

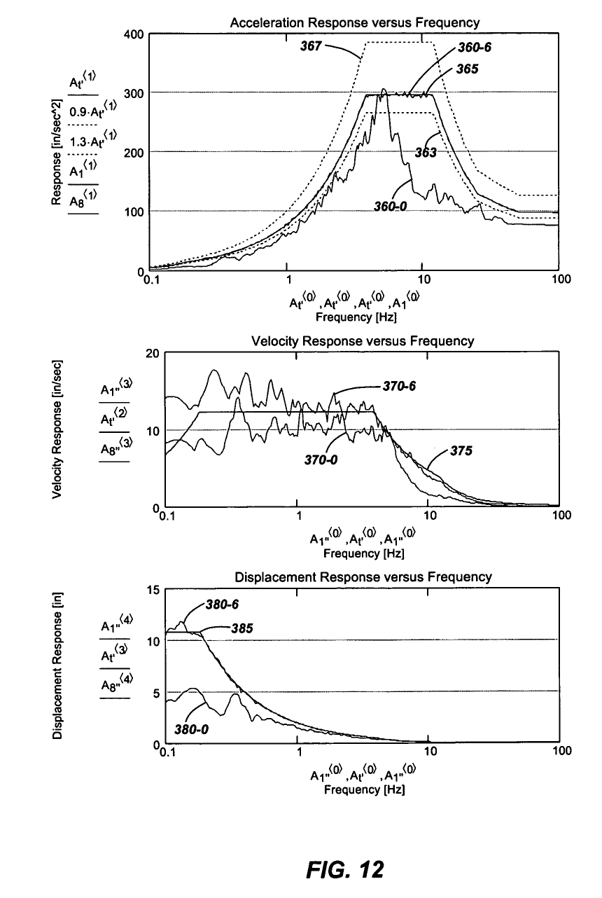

FIG. 12 illustrates response spectra for acceleration, velocity, and displacement relative to the desired response spectra after the sixth spectral matching process 290 of FIG. 6A. In the upper graph of FIG. 12, the initial acceleration response 360-0, the standard acceleration response 365, the upper limit acceleration response 367 and the lower limit acceleration response 363 are shown for reference. When compared to the fifth acceleration response 360-5 in FIG. 11, it can be seen that the amplitudes for a sixth acceleration response 360-6 across the entire spectrum have been refined to even further limit spikes and very closely match the standard acceleration response 365.

In the middle graph of FIG. 12, the initial velocity response 370-0 and a sixth velocity response 370-6 are shown relative to the standard velocity response 375. As can be seen, the sixth velocity response 370-6 remains acceptably close to the standard velocity response 375.

In the lower graph of FIG. 12, the initial displacement response 380-0 and a sixth displacement response 380-6 are shown relative to the standard displacement response 385. The sixth displacement response 380-6, resulting from the sixth spectral matching process 290 of FIG. 6A, remains very closely matched to the standard displacement response 385.

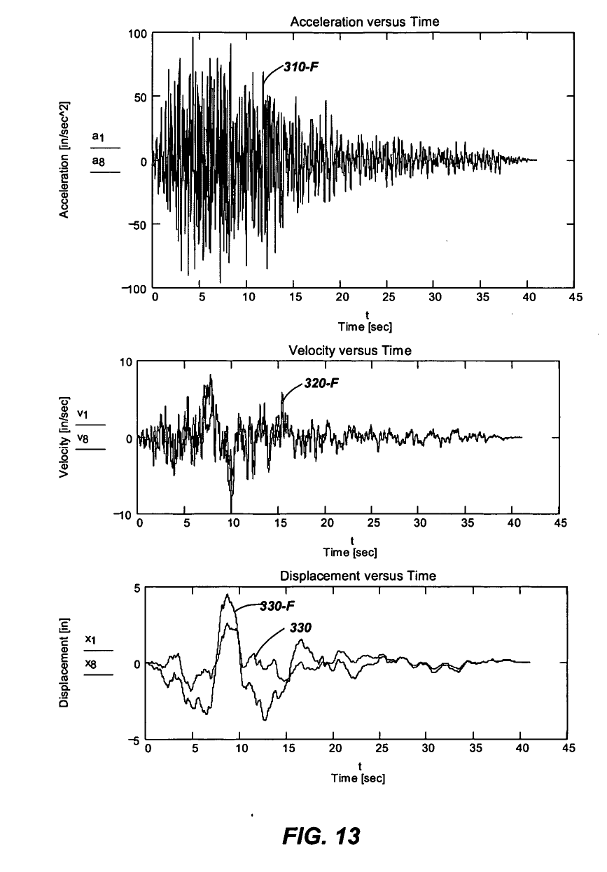

FIG. 13 illustrates the final acceleration time history 310-F, final velocity time history 320-F, and final displacement time history 330-F. For comparison, the initial displacement time history 330 is also shown in FIG. 13. FIG. 13 does not illustrate the initial acceleration time history and initial velocity time history because the differences are difficult to discern.

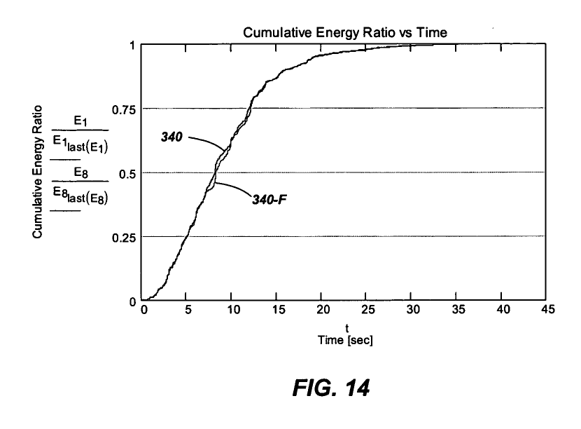

FIG. 14 illustrates the initial cumulative energy ratio 340 over time for the initial acceleration time history 310 of FIG. 2 and the final cumulative energy ratio 340-F after the sixth spectral matching process.

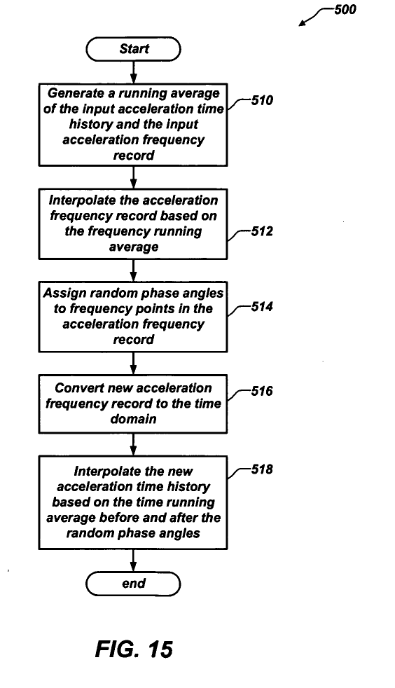

FIG. 15 illustrates a spectral modification process 500 to generate an acceleration time history with low correlation to an initial acceleration time history. For some standards, such as ASCE/SEI 43-05, multiple acceleration time histories may be required and the multiple acceleration time histories should have low correlation relative to one another. These multiple low-correlation time histories may be used for both linear and non-linear modeling but are particularly useful in non-linear modeling of a seismic events effect on a structure. As a non-limiting example, ASCE/SEI 43-05 requirements indicate that acceleration time histories should have a correlation of less than 0.30.

Generally, a process may begin with an initial seed acceleration time history representing an earthquake, perhaps from actual empirical data. Multiple low-correlation acceleration time histories may be generated from the initial seed acceleration time history using a spectral modification process described below. Then, each of the low-correlation acceleration time histories may undergo a spectral matching process as described above.

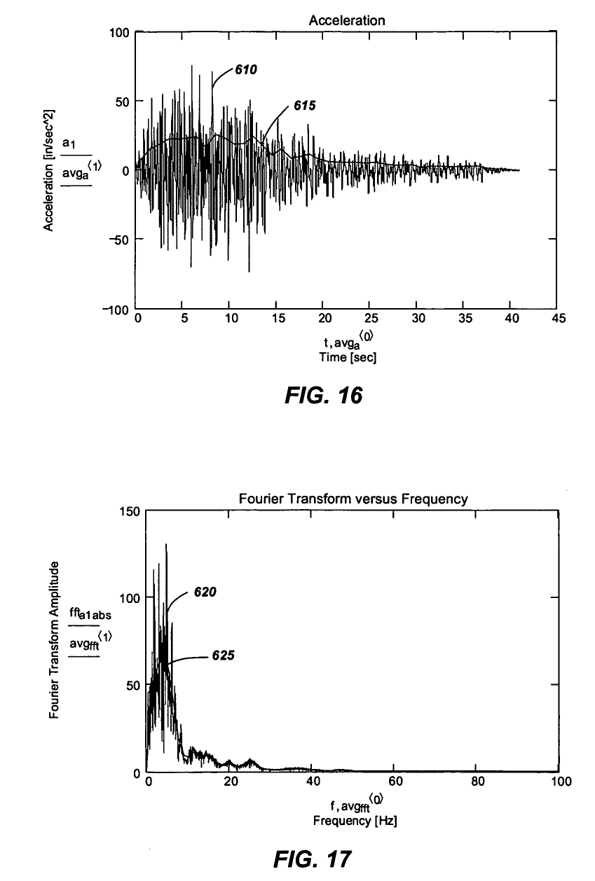

The spectral modification process 500 uses averaged parameters of the input acceleration time history to shape white noise for generation of a low-correlation acceleration time history. Operation block 510 generates running average amplitudes for the input acceleration time history in the time domain and the frequency domain. FIG. 16 shows the input acceleration time history 610 and an average time amplitude 615 averaged over 200 data point intervals. FIG. 17 shows the input acceleration frequency record 620 (i.e., the initial acceleration time history in the frequency domain) and an average frequency amplitude 625 averaged over 50 data point intervals. The number of data points used in the averaging intervals is a non-limiting example intended to produce relatively smooth results.

Returning to FIG. 15, operation block 512 uses the average frequency amplitude 625, to generate a new acceleration frequency record with the correct number of data points using interpolation.

Operation block 514 assigns substantially random phase angles to some, or all, of the data points in the new acceleration frequency record. Those of ordinary skill in the art will recognize that while only amplitudes are illustrated in the frequency domain plot a corresponding phase angle exists for each frequency data point. Assigning substantially random phase angles creates a low-correlation between the initial acceleration frequency record and an acceleration frequency record with the new substantially random phase angles. Operation block 516 converts the new acceleration frequency record to a new acceleration time history. As a non-limiting example an inverse Fourier transform may perform this operation.

Operation block 518 calculates running average amplitudes for the new acceleration time history in a manner similar to that for the initial time history in operation block 510. A ratio of the initial running average to the new running average is used to modify the new acceleration time history so it has an amplitude variation through time (i.e., shape) and cumulative energy similar to that of the initial acceleration time history.

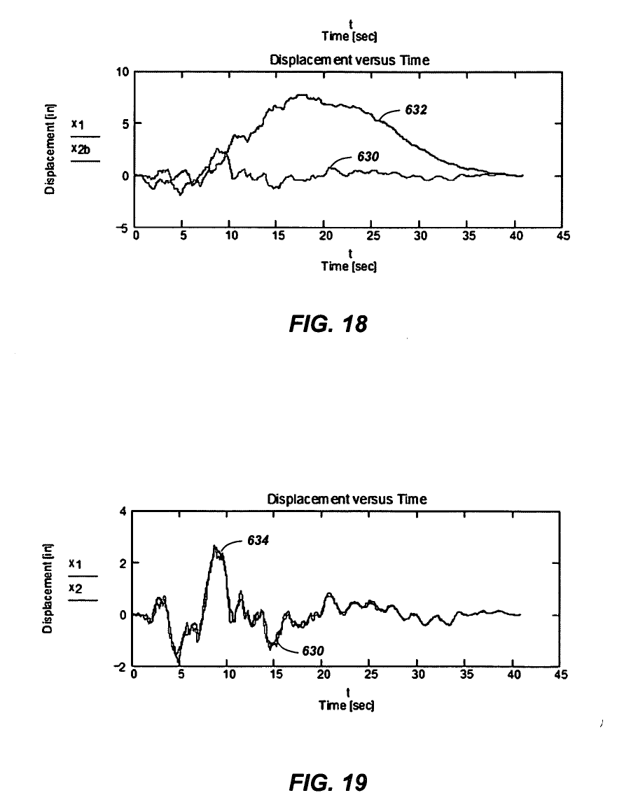

In some instances, the low-correlation process may generate new displacement and velocity time histories that deviates significantly from the initial displacement and velocity time histories. FIG. 18 illustrates an initial displacement time history 630 and a new displacement time history 632 after the randomization process. In order to make the new displacement and velocity time histories match the initial displacement and velocity time histories more closely, additional processes may be performed as part of the spectral modification process 500. These processes may include the first spectral matching process 210 (FIG. 6A), the cumulative energy scaling, and the boundary scaling discussed above.

FIG. 19 illustrates a final displacement time history 634 relative to the initial displacement time history 630 after the first spectral matching process, cumulative energy scaling and boundary scaling.

For the example shown in FIGS. 16 and 17, this spectral modification process 500 produced a correlation of 0.024 which is well below the 0.30 requirement of ASCE/SEI 43-05.

Although the present invention has been described with reference to particular embodiments, the present invention is not limited to these described embodiments. Rather, the present invention is limited only by the appended claims, which include within their scope all equivalent devices or methods that operate according to the principles of the present invention as described.

What is claimed is:

1. A method of generating a desired acceleration time history, comprising:
supplying a response model comprising a plurality of natural frequencies across a spectrum of interest;
generating a second acceleration time history by:
determining a displacement response by applying a first acceleration time history to the response model;
comparing the displacement response to a standard displacement response over at least a low frequency band of the spectrum of interest to determine a first set of low-frequency enhancement signals across the low frequency band; and
producing the second acceleration time history by combining the first set of low-frequency enhancement signals with the first acceleration time history;
generating a third acceleration time history by:
determining an acceleration response by applying the second acceleration time history to the response model;
comparing the acceleration response to a standard acceleration response across at least a high frequency band of the spectrum of interest to determine a first set of high-frequency enhancement signals across the high frequency band; and
producing the third acceleration time history by combining the first set of high-frequency enhancement signals with the second acceleration time history; and
outputting the third acceleration time history as the desired acceleration time history.

2. The method of claim 1, further comprising:
determining an additional displacement response by applying the third acceleration time history to the response model;
comparing the additional displacement response to the standard displacement response at the low frequency band of the spectrum of interest to determine a second set of low-frequency enhancement signals across the low frequency band;
producing a fourth acceleration time history by combining the second set of low-frequency enhancement signals with the third acceleration time history; and
outputting the fourth acceleration time history as the desired acceleration time history.

3. The method of claim 2, further comprising:
generating an additional acceleration response by applying the fourth acceleration time history to the response model;
comparing the additional acceleration response to the standard acceleration response at the high frequency band of the spectrum of interest to determine a second set of high-frequency enhancement signals across the high frequency band;
producing a fifth acceleration time history by combining the second set of high-frequency enhancement signals with the fourth acceleration time history; and
outputting the fifth acceleration time history as the desired acceleration time history.

4. The method of claim 1, wherein generating the second acceleration time history further comprises:
determining a new displacement response by applying the second acceleration time history to the response model;
comparing the new displacement response to the standard displacement response over at least the low frequency band of the spectrum of interest to determine a new set of low-frequency enhancement signals across the low frequency band;
producing the second acceleration time history by combining the new set of low-frequency enhancement signals with the second acceleration time history; and
repeating determining a new displacement response, comparing the new displacement response, and producing the second acceleration time history until the new displacement response matches the standard displacement response across the low frequency band within a displacement margin.

5. The method of claim 1, wherein generating the third acceleration time history further comprises:
determining a new acceleration response by applying the third acceleration time history to the response model;
comparing the new acceleration response to the standard acceleration response over at least the high frequency band of the spectrum of interest to determine a new set of high-frequency enhancement signals across the high frequency band;
producing the third acceleration time history by combining the new set of high-frequency enhancement signals with the third acceleration time history; and
repeating determining a new acceleration response, comparing the new acceleration response, and producing the third acceleration time history until the new acceleration response matches the standard acceleration response across the high frequency band within an acceleration margin.

6. The method of claim 1, further comprising generating the first acceleration time history from an initial acceleration time history by:
determining an initial acceleration response by applying the initial acceleration time history to the response model;
generating a target acceleration response comprising weighted differences between the initial acceleration response and the standard acceleration response;
converting the target acceleration response to a time domain to generate a target acceleration adjustment; and
combining the target acceleration adjustment and the initial acceleration time history to generate the first acceleration time history.

7. The method of claim 1, further comprising generating the first acceleration time history from an initial acceleration time history by:
determining an initial displacement response by applying the initial acceleration time history to the response model;
generating a target displacement response comprising weighted differences between the initial displacement response and the standard displacement response;
converting the target displacement response to a target acceleration response;
converting the target acceleration response to a time domain to generate a target acceleration adjustment; and
combining the target acceleration adjustment and the initial acceleration time history to generate the first acceleration time history.

8. The method of claim 1, wherein the spectrum of interest comprises at least three decades above about 0.1 Hz, and the plurality of frequencies comprises at least 100 frequencies per decade.

9. The method of claim 1, further comprising:
converting the desired acceleration time history to a frequency domain to create a desired acceleration frequency record;
inserting substantially random phase angles at each frequency point in the desired acceleration frequency record to generate a low-correlation acceleration frequency record;
converting the low-correlation acceleration frequency record to a time domain to a create a low-correlation acceleration time history; and
scaling each point of the low-correlation acceleration time history by a scale factor proportional to a ratio of a highest amplitude of the desired acceleration time history relative to a highest amplitude of the low-correlation acceleration time history.

10. A method of generating a desired acceleration time history, comprising:
supplying a response model comprising a plurality of natural frequencies across a spectrum of interest;
applying a first acceleration time history to the response model to develop a displacement response:
determining a set of low-frequency enhancement signals across a lower band of the spectrum of interest by comparing the displacement response to a standard displacement response;
combining the set of low-frequency enhancement signals with the first acceleration time history to develop a second acceleration time history;
applying the second acceleration time history to the response model to develop an acceleration response;
determine a set of high-frequency enhancement signals across an upper band of the spectrum of interest by comparing the acceleration response to a standard acceleration response; and
combining the set of high-frequency enhancement signals with the second acceleration time history to develop the desired acceleration time history.

11. The method of claim 10, further comprising:
determining an additional displacement response by applying the desired acceleration time history to the response model;
comparing the additional displacement response to the standard displacement response across the lower band to determine a second set of low-frequency enhancement signals;
producing a fourth acceleration time history by combining the second set of low-frequency enhancement signals with the desired acceleration time history; and
outputting the fourth acceleration time history as the desired acceleration time history.

12. The method of claim 11, further comprising:
generating an additional acceleration response by applying the desired acceleration time history to the response model;
comparing the additional acceleration response to the standard acceleration response across the upper band to determine a second set of high-frequency enhancement signals;
producing a fifth acceleration time history by combining the second set of high-frequency enhancement signals with the fourth acceleration time history; and
outputting the fifth acceleration time history as the desired acceleration time history.

13. The method of claim 10, further comprising generating the first acceleration time history from an initial acceleration time history by:
determining an initial acceleration response by applying the initial acceleration time history to the response model;
generating a target acceleration response comprising weighted differences between the initial acceleration response and the standard acceleration response;
converting the target acceleration response to a time domain to generate a target acceleration adjustment; and
combining the target acceleration adjustment and the initial acceleration time history to generate the first acceleration time history.

14. The method of claim 10, further comprising generating the first acceleration time history from an initial acceleration time history by:
determining an initial displacement response by applying the initial acceleration time history to the response model;
generating a target displacement response comprising weighted differences between the initial displacement response and the standard displacement response;
converting the target displacement response to a target acceleration response;
converting the target acceleration response to a time domain to generate a target acceleration adjustment; and
combining the target acceleration adjustment and the initial acceleration time history to generate the first acceleration time history.

15. A method of generating a desired acceleration time history, comprising:
converting an initial acceleration time history to a frequency domain to create an initial acceleration frequency record;
determining a running time average by averaging a plurality of contiguous points across the initial acceleration time history;
determining a running frequency average by averaging a plurality of contiguous points across the initial acceleration frequency record;
interpolating between the initial acceleration frequency record and the running frequency average to generate an intermediate frequency record;
inserting substantially random phase angles at a plurality of frequency points in the intermediate frequency record;
converting the intermediate frequency record to a time domain to a create an intermediate time history; and
interpolating between the intermediate time history and the running time average to generate a low-correlation acceleration time history.

16. A computing system, comprising:
a memory configured for storing computing instructions; and
a processor operably coupled to the computing system and configured for executing the computing instructions to:
generate a second acceleration time history by:
determining a displacement response by applying a first acceleration time history to a response model configured with a plurality of natural frequencies across a spectrum of interest;
comparing the displacement response to a standard displacement response over at least a low frequency band of the spectrum of interest to determine a first set of low-frequency enhancement signals across the low frequency band; and
producing the second acceleration time history by combining the first set of low-frequency enhancement signals with the first acceleration time history;
generate a third acceleration time history by:
determining an acceleration response by applying the second acceleration time history to the response model;
comparing the acceleration response to a standard acceleration response across at least a high frequency band of the spectrum of interest to determine a first set of high-frequency enhancement signals across the high frequency band; and
producing the third acceleration time history by combining the first set of high-frequency enhancement signals with the second acceleration time history; and
output the third acceleration time history as a desired acceleration time history.

17. The computing system of claim 16, wherein the processor is configured for executing additional computing instructions for:
determining an additional displacement response by applying the third acceleration time history to the response model;
comparing the additional displacement response to the standard displacement response at the low frequency band of the spectrum of interest to determine a second set of low-frequency enhancement signals across the low frequency band;
producing a fourth acceleration time history by combining the second set of low-frequency enhancement signals with the third acceleration time history; and
outputting the fourth acceleration time history as the desired acceleration time history.

18. The computing system of claim 17, wherein the processor is configured for executing additional computing instructions for:
generating an additional acceleration response by applying the fourth acceleration time history to the response model;
comparing the additional acceleration response to the standard acceleration response at the high frequency band of the spectrum of interest to determine a second set of high-frequency enhancement signals across the high frequency band;
producing a fifth acceleration time history by combining the second set of high-frequency enhancement signals with the fourth acceleration time history; and
outputting the fifth acceleration time history as the desired acceleration time history.

19. The computing system of claim 16, wherein the processor is configured for executing additional computing instructions for generating the second acceleration time history by:
determining a new displacement response by applying the second acceleration time history to the response model;
comparing the new displacement response to the standard displacement response over at least the low frequency band of the spectrum of interest to determine a new set of low-frequency enhancement signals across the low frequency band;
producing the second acceleration time history by combining the new set of low-frequency enhancement signals with the second acceleration time history; and
repeating determining a new displacement response, comparing the new displacement response, and producing the second acceleration time history until the new displacement response matches the standard displacement response across the low frequency band within a displacement margin.

20. The computing system of claim 16, wherein the processor is configured for executing additional computing instructions for generating the third acceleration time history by:
determining a new acceleration response by applying the third acceleration time history to the response model;
comparing the new acceleration response to the standard acceleration response over at least the high frequency band of the spectrum of interest to determine a new set of high-frequency enhancement signals across the high frequency band;
producing the third acceleration time history by combining the new set of high-frequency enhancement signals with the third acceleration time history; and
repeating determining a new acceleration response, comparing the new acceleration response, and producing the third acceleration time history until the new acceleration response matches the standard acceleration response across the high frequency band within an acceleration margin.

21. The computing system of claim 16, wherein the processor is configured for executing additional computing instructions for generating the first acceleration time history from an initial acceleration time history by:
determining an initial acceleration response by applying the initial acceleration time history to the response model;
generating a target acceleration response comprising weighted differences between the initial acceleration response and the standard acceleration response;
converting the target acceleration response to a time domain to generate a target acceleration adjustment; and
combining the target acceleration adjustment and the initial acceleration time history to generate the first acceleration time history.

22. A computer-readable media including computer executable instructions, which when executed on a processor perform acts, comprising:
developing a displacement response by applying a first acceleration time history to a response model configured with a plurality of natural frequencies across a spectrum of interest:
determining a first set of low-frequency enhancement signals across a lower band of the spectrum of interest by comparing the displacement response to a standard displacement response;
combining the first set of low-frequency enhancement signals with the first acceleration time history to develop a second acceleration time history;
applying the second acceleration time history to the response model to develop an acceleration response;
determine a first set of high-frequency enhancement signals across an upper band of the spectrum of interest by comparing the acceleration response to a standard acceleration response;
combining the first set of high-frequency enhancement signals with the second acceleration time history to develop a desired acceleration time history; and
outputting the desired acceleration time history.

23. The computer-readable media of claim 22, wherein the computer executable instructions cause the processor to perform the act of generating the second acceleration time history by:
determining a new displacement response by applying the second acceleration time history to the response model;
comparing the new displacement response to the standard displacement response over at least the lower band of the spectrum of interest to determine a new set of low-frequency enhancement signals across the lower band;
producing the second acceleration time history by combining the new set of low-frequency enhancement signals with the second acceleration time history; and
repeating determining a new displacement response, comparing the new displacement response, and producing the second acceleration time history until the new displacement response matches the standard displacement response across the lower band within a displacement margin.

24. The computer-readable media of claim 22, wherein the computer executable instructions cause the processor to perform the act of generating the third acceleration time history by:
determining a new acceleration response by applying the third acceleration time history to the response model;
comparing the new acceleration response to the standard acceleration response over at least the upper band of the spectrum of interest to determine a new set of high-frequency enhancement signals across the upper band;
producing the third acceleration time history by combining the new set of high-frequency enhancement signals with the third acceleration time history; and
repeating determining a new acceleration response, comparing the new acceleration response, and producing the third acceleration time history until the new acceleration response matches the standard acceleration response across the upper band within an acceleration margin.

25. The computer-readable media of claim 22, wherein the computer executable instructions cause the processor to perform the act of generating the first acceleration time history from an initial acceleration time history by:
determining an initial displacement response by applying the initial acceleration time history to the response model;
generating a target displacement response comprising weighted differences between the initial displacement response and the standard displacement response;
converting the target displacement response to a target acceleration response;
converting the target acceleration response to a time domain to generate a target acceleration adjustment; and
combining the target acceleration adjustment and the initial acceleration time history to generate the first acceleration time history.
